(19) United States
(12) Patent Application Publication
(10) Pub. No.: US 2022/0091626 A1
(43) Pub. Date: Mar. 24, 2022

(54) DEVICE AND METHOD FOR READING A POSITIONAL RELATIONSHIP BETWEEN TWO COMPONENTS

(71) Applicant: GIFS AS, Røyneberg (NO)

(72) Inventor: Bjørn Nøstvold, Røyneberg (NO)

(73) Assignee: GIFS AS, Røyneberg (NO)

(21) Appl. No.: 17/419,599

(22) PCT Filed: Jan. 28, 2020
(86) PCT No.: PCT/NO2020/050016

§ 371 Date: Jun. 29, 2021

(30) Foreign Application Priority Data
Jan. 30, 2019 (NO) 20190108

(51) Int. Cl. G05G 9/047; G02B 27/30

(52) U.S. Cl. CPC G05G 9/047; G05G 2009/04759; G02B 27/30

(57) ABSTRACT

A reading device is for reading a positional relationship between a first component and a second component. The first component has an optical sensor and the second component has a collimator configured for directing a light beam at the optical sensor. A method is for reading a positional relationship between two components, the method including passing light through a collimator in a first component towards an optical sensor in a second component, reading the position of the light beam from the collimator on the optical sensor, and calculating the positional relationship between the first and second components from the position of the light beam on the optical sensor.

### CROSS-REFERENCE TO RELATED APPLICATIONS

This application is the U.S. national stage application of International Application PCT/NO2020/050016, filed Jan. 28, 2020, which international application was published on Aug. 6, 2020, as International Publication WO 2020/159378 in the English language. The International Application claims priority of Norwegian Patent Application No. 20190108, filed Jan. 30, 2019. The international application and Norwegian application are both incorporated herein by reference, in entirety.

### FIELD

The invention relates to a reading device and a method for reading a positional relationship between two components.

### BACKGROUND

The challenge that one is faced with when a position reading is to be done on a movable part relative to a static part is how to make a device that is robust in relation to mechanical wear. In addition, it is a challenge to achieve high accuracy and repeatability in the position readings, and to find a solution that does not give erroneous readings caused by external influences.

Prior art for position reading in a joystick, for example, is using a potentiometer. A potentiometer is an adjustable voltage divider which is a mechanical device that is subjected to mechanical wear, and thereby, over time, subject to a change in characteristic and, thus, liable to give erroneous readings, and a potentiometer has a limited life.

An advancement of the technique which is used to a great extent in a joystick is the use of a Hall-effect sensor, which is an electronic component whose signal level changes with a change in magnetic fields to which it is exposed. The movable part of a joystick may then be equipped with magnets which change the signal level in the Hall-effect sensors that are mounted on the static part of the device when the movable part changes position. A drawback is that the device may be influenced by external magnetic fields which may then give erroneous readings. A variation in temperature may also give erroneous readings.

A known technique is using one or more light sources, and by changing the position of the joystick, one or more photodiodes or optical sensors are lit to indicate the joystick position. There are several variants and solutions here, but a drawback is that they have a certain drift by temperature changes and need electronic solutions that, to a certain extent, compensate for erroneous readings caused by temperature drift.

U.S. Pat. No. 4,587,510 discloses an analogue joystick which uses potentiometers to read the position. A drawback of using potentiometers is that a potentiometer is a mechanical structure that is subjected to wear and has a limited life. Another drawback is that, with respect to linearity of the signal, the characteristic may change over time, the device give erroneous readings and need repeated calibrations.

U.S. Pat. No. 4,459,578 discloses a variant of a joystick that makes use of Hall-effect sensors to read the position. This is an advancement in relation to using potentiometers which involves using components for position reading that are not liable to mechanical wear. A drawback of the method is that the device is prone to erroneous readings and drift of the signal if influenced by temperature changes or by magnetic fields that are not part of the device.

US20020080050A1 discloses an inductive joystick. An advantage of this type of joystick is that it does not have components that contributes to a drift of the signal. A drawback is that, in such a joystick, the signal may be disturbed by radio waves. Another drawback is that the device can detect movements only in the x- and y-direction.

EP1696300A1 discloses an optical joystick which has a light source that generates a conical light beam with an increasing diameter out from the light source, and that illuminates a major number of optical sensors simultaneously. A drawback of the solution is that one cannot make use of the possibility of resolution that modern sensors can give as they can have a distance between the optical sensors in the μm range, and a conical light beam will illuminate an increasing number of sensors the further out from the neutral position the light beam gets. The light source is arranged at a considerable distance from the pivotal point of the joystick and towards the optical sensors and will thus not be suitable for making use of modern sensors because of the large movement that the light beam will have when the handle of the joystick is being moved.

U.S. Pat. No. 6,232,959 discloses an optical mouse or joystick which uses a laser to carry out a position determination on an array of optical sensors. In a mouse or joystick, one will be restricted to using miniature lasers in which a typical diameter of the light beam is in the region of 1 mm. Such a large diameter of the light beam will not be able to make use of the resolution that current optical sensors may give, which may be of a magnitude of under 2 μm. Methods for focusing the laser beam by using focusing coils and light-directing lenses are also disclosed. The drawback of using a focusing coil is that the light beam gets a focal point in which the minimal diameter is obtained, and in which the light beam will be more out of focus, and will get an enlarged diameter when the joystick moves the light out of the focal point. This will then apply to devices in which the manoeuvring lever pivots around a pivotal point. Another drawback is that the beam-directors described, which may contain lasers, focusing coils and light reflectors, are built between the pivotal point of the joystick and the optical array. If the distance from the pivotal point of the joystick to the optical array gets to be too large, even slight movements of the manoeuvring part of the joystick will result in the movements of the light spots becoming too large for most standard optical sensors to be usable. The entire optical array of an image sensor is typically in the order of 5-3 mm.

WO1997005567 discloses an optical joystick which is designed for use opposite a PSD (position sensitive detector) or a photodiode quadrant, and which uses an aperture plate which is fixed in the housing of the joystick between the light source and the optical sensor. The light spot that is formed is described as larger than the aperture of the aperture plate. When the light source that is part of the movable part of the joystick is moved, the light spot formed by the light passing through the aperture plate will change its position on the optical sensor. A drawback of using a PSD is that it may give erroneous readings by temperature changes. A quadrant of photodiodes has primarily been developed to detect a centre point between the four photodiodes and is not very accurate for determining the position of the light spot outside the centre point. Thus, a quadrant of photodiodes is not the ideal component to be used for determining the position of a joystick that needs accurate positioning over the entire moving area of the joystick. Such a component will thus be able to give just 4 absolute position points and must use varying analogue values on the four photodiodes to calculate the position of the light spot. Then, when the analogue values may change by a temperature change, such a solution will give relatively poor accuracy in relation to using, for example, an image sensor with 16 million absolute position points.

US20070126700A1 discloses a device which uses light from, for example, a light emitting diode or a laser which is reflected from a plate with an uneven surface attached to the movable part of, for example, a joystick, in which the light falls on a PSD. This may detect in which direction the joystick is moving and thus, by means of software, calculate a position of the joystick. A drawback of using PSDs is that they do not have high accuracy with respect to erroneous readings or so-called drift by temperature changes, for example. To compensate for this, it has been suggested to include reference points in the plate with the uneven surface in order to be able to detect a zero every time the joystick is in this position and use this to continuously calibrate the joystick and reduce drift. Another drawback is that the solution thus requires software which is continuously to correct errors created by the components.

U.S. Pat. No. 6,081,257 discloses another reading device.

### SUMMARY

The invention has for its object to remedy or reduce at least one of the drawbacks of the prior art or at least provide a useful alternative to the prior art.

An object of the invention is to provide a device for position reading, in which the position transmitter is not subject to mechanical wear. An object is also to provide a device for position reading which can make use of current optical sensors to utilize the possibility that these give for a higher resolution in the position signal than what can be offered by the technology today. A further object is to provide a device for position reading which is not affected by external elements such as temperature, magnetic fields or radio waves. Another object is to provide a device which has an absolute position determination with 100% repeatability. An object is to provide a device which does not require extra software to maintain calibration or need a start-up calibration or calibration after a power failure.

The object is achieved through the features that are specified in the description below and in the claims that follow.

The invention is defined by the independent claims. The dependent claims define advantageous embodiments of the invention.

The invention relates, more specifically, to a reading device for reading a positional relationship between a first component and a second component, the first component comprising an optical sensor and the second component comprising a collimator configured for directing a light beam at the optical sensor by the collimator comprising a collimator housing with two openings opposite each other, each in a respective end part of the collimator housing. The optical sensor must be able to detect a change in the position of the light beam. A change in the positional relationship between the two components may thereby result in a change in the position of the light beam on the optical sensor. For example, if the second component is movable around a pivotal point which is fixed relative to the first component, a relative change in the angle between the first and second components may be read from the position of the light beam on the optical sensor. Alternatively, if the angle is kept constant, a change in the translational position of the second component parallel to the plane of the optical sensor may be read from the position of the light beam on the optical sensor. Herein, the plane of the optical sensor is called the x-y plane, whereas the direction parallel to the normal to the optical sensor is called the z-axis.

A collimator will, in this connection, indicate a device which gives a mainly unidirectional light beam from a light source. The collimator may, for example, comprise a collimator housing with two small openings opposite each other, each in a respective end part of the housing. The collimator housing may be closed, apart from the two openings. Light from one side of the collimator may enter through the first opening in different directions, whereas the light exiting through the opposite opening will essentially be a light beam that comes directly from the first opening. The degree of collimation of the light beam may be increased by having smaller openings, a larger distance between the openings, and by the collimator having a surface that absorbs light on its inside. Alternatively, the collimator may include a long and thin opening, for example an almost solid cylinder with only a narrow axial opening. The light source may be a lamp on the opposite side of the collimator to the optical sensor, for example an LED, it may be light existing outside the collimator, or light that is carried to the collimator via optical fibres.

Using a collimator has the advantage of allowing the light beam easily to be made very narrow, having substantially the same cross section after the collimator independently of the distance therefrom. This will have the advantage of the area on the optical sensor that is illuminated by the light beam not changing in size if the angle or distance between the two components changes. The light beam after the collimator may, for example, be arranged to have a cross section of an extent smaller than 50 μm, smaller than 25 μm or smaller than 10 μm, for example in the order of 1 μm. A narrow light beam may enable a high position resolution and make the reading device small.

The optical sensor may, for example, be an optical array of small individual sensors, for example an image sensor similar to those used in digital cameras. Each individual sensor is called a pixel. An optical array, for example an image sensor, may have small pixel sizes, each pixel being able to detect light. For example, the optical sensor may have a pixel size of an extent smaller than 50 μm, smaller than 25 μm or smaller than 10 μm, for example in the order of 1 μm. Such optical sensors with a small pixel size may also enable a high position resolution and make the reading device small.

The combination of a collimator with a microscopic light beam and an image sensor with a microscopic pixel size may therefore give a particularly high position resolution; the reading device may be made very small at the same time, and it is not affected by external factors such as magnetic fields or radio waves. This may open up new areas of application in relation to existing reading devices.

The collimator may further be configured for directing a second light beam at the optical sensor, whereby a relative rotation between the first and second components may be calculated. Alternatively, reading a relative rotation may be enabled if the cross section of the light beam is not circular but, for example, elongated.

The collimator may further be so configured that at least two light beams hit the optical sensor at different angles. In this way, a change in the distance between the two components will result in a change in the distance between the two light spots on the optical sensor. When the angles of the light beams are known, the distance between the two light spots can therefore be converted to a distance between the two components if the angle between these components is known.

In a second aspect, the invention relates to a method for reading a positional relationship between two components, the method comprising the steps of: passing light through a collimator in a second component towards an optical sensor in a first component, the collimator comprising a collimator housing with two openings opposite each other, each in a respective end part of the collimator housing; reading the position of the light beam from the collimator on the optical sensor; and calculating the positional relationship between the first and second components from the position of the light beam on the optical sensor. The positional relationship between the two components may, for example, be read by using the reading device according to the first aspect of the invention.

The reading device may, for example, be used in a joystick or an inclinometer.

In one embodiment, the invention relates to a reading device in the form of a joystick in which the handle element, which may be of various designs, has one or more light sources which receive energy via the shaft element of the joystick, wherein, according to the prior art, the light source may be provided with a battery and control circuits to ensure a stable supply to the light source to maintain a constant light intensity. The joystick may also use batteries of replaceable types, or rechargeable batteries in the handle element receiving energy by the batteries being charged, when required, when the joystick is not in use. As an alternative to a built-in light source, it is possible to use light existing outside the device and carry the light into the device through an aperture which may be a material of a translucent material or prisms. An alternative to letting the light in through an aperture may be letting the light into the device via one or more optical fibres. Here, a variant which continuously supplies the light source with energy via the shaft element and the pivotal point of the shaft element will be explained. As an extension of the lower end of the handle element, a preferably tubular extension rotatable relative to a shaft element continues. The tubular extension may also be fitted to the handle element as a separate part. The shaft element surrounding the tubular extension functions as a link between the handle element and the ball joint and is adapted for functioning also as a support for the rotation of the tubular extension. The support of the tubular extension may also be free-standing supports. The shaft element is attached to the handle element in a way that enables rotation of the handle element and the tubular extension relative to the shaft element. The shaft element and the tubular extension are preferably made from an electrically nonconductive material. The shaft element is attached to the ball in a ball joint which functions as a pivotal point for moving the joystick in the x-y plane. To achieve continuous energy supply to the light source, the ball may consist of two parts and be made of an electrically conductive material, the two halves of the ball having an insulating material between each half. The ball is held in place by two halves joined together, which, together with the ball, form a ball joint. In one or both of the halves holding the ball in place, electrical brushes are arranged, which will each be in electrical contact with a respective half of the ball. An electrical connection is arranged via the electrical brushes, the material of the ball, the shaft element to the control circuit of the light source, which may contain voltage regulation and current-limiting electronics for adaptation to a possible light emitting diode as the light source. The control circuit may also contain control circuits for charge control of a battery to further make the supply of power to the light source more stable. Continuous power supply to the light source may also be provided by there being an electrical coil arranged in the halves holding the ball of the ball joint, and by the ball of the ball joint having a built-in coil and the light source receiving its charging voltage by inductive transmission of power from the static part to the movable part. In the ball joint, a guiding groove is arranged, there being guide pins arranged in the halves of the ball joint, extending into the guiding groove. The ball may thus be moved freely in the ball joint, but a rotation of the ball is impossible. The bottom half of the ball joint is attached to a base in which the optical sensors and, possibly, electronic circuits for processing signals from the optical sensors are installed. Circuits for processing signals from the optical sensors may also be placed outside the reading device. The optical sensors are shielded from influence from external light by a casing having been installed between the base and the ball-joint arrangement. The casing may also be in one piece and consist of side walls and a bottom, which function as a base for mounting the optical sensors and possibly associated electronic circuits. In the rotatable tubular extension, there is a device which has one or more microscopic apertures. The device with the microscopic apertures may consist of a circular plate with one or more microscopic openings, and a device with apertures is installed at either end of the tubular extension. The device with the microscopic apertures may consist of a piece in which the ratio of the diameter of the microscopic passage to the length of the passage makes the light beam that exits the tubular extension not have any significant diffusion of light, but be an approximately 100% collimated light beam. The devices having the microscopic apertures may preferably be covered by a glass plate or some other transparent material to avoid blocking of the apertures by possible impurities, and make it easier to clean such contamination, if any. This device is a collimator. The light beams may be of varying shapes, but preferably have a circular shape. The lower part of the collimator, where the collimated light exits, has a positioning preferably at the centre of the ball, also called the pivotal point of the movable part. In this way, the point where the light exits the collimator will not have any movement in the horizontal plane relative to the static part of the device, but when the handle element is moved, only the angle of the collimated light will change. The result of this is that even if the movements of the handle element of a joystick are large, it is possible to use even the smallest optical arrays which may have a length and a width of just 4-5 mm. The invention may thus be used on even the smallest joysticks or computer mice.

When the handle element is being moved, the collimated light beam will move across an array of optical sensors, and the optical array may thus give an absolute position indication of the position of the joystick with a degree of resolution determined by the number of optical sensors that the optical array has, also called number of pixels. The resolution will not be limited just to how many pixels the optical array has. An optical array may have a 14-bit resolution which will correspond to values from 0-16383. This means that, from no light influence to light influence giving a maximum signal, a pixel will give a signal that varies with values from 0-16383. By using this possibility, the device may be given a further increased degree of resolution. A person skilled in the art may use a known position on the optical array generated by the collimated light to convert the signal to a desired output signal adapted for the control system of the user equipment. The output signal may be transmitted from the reading device to the control system of the user equipment via a cabled connection or via prior-art wireless data-transmission systems. By removing the handle element from the ball of the ball joint, the light source and collimator may be moved from the handle element to the ball, and by equipping the device with mouse buttons, the device may be used as a computer mouse of the trackball type with an absolute position indication. A joystick of this type will also be well suited as a mouse for computers where high precision is essential.

In a second embodiment, the invention relates to a reading device in the form of an inclinometer in which a pendulum is suspended from a frame structure, and in which a light source and a collimator are arranged in the pendulum. The collimated light is directed at an optical array which is mounted on the bottom frame of the structure. The bottom frame may be fixed to the supporting surface which is to be monitored for angular changes. The bottom frame may have adjustments so that, after having been installed on the supporting surface, it may be adjusted in such a way that the collimated light will have a starting point that is at the centre of the optical array. An angular change in the supporting surface will result in the pendulum with the collimated light moving on the optical array, and the amount of angular change and also the direction of the angular change may be read. The bottom frame and the frame structure will be made lightproof so that only light from the collimator illuminates the optical array. The inclinometer may be installed in varying forms of frame structures, such as in a pipe. With advantage, for constructing the inclinometer, materials that are stable with respect to temperature changes may be used to minimize erroneous readings. Where a great degree of accuracy is to be monitored over time, the inclinometer may, for example, be installed in a habitat having a stable temperature. Such inclinometers may, for example, be used for monitoring the stability of structures over time or be used in geological monitoring or in adjusting installations into a desired angle. The inclinometer may have control electronics which make measurements continuously or at desired intervals, wherein data may be read directly from the inclinometer or be stored on a built-in storing medium. Data may also be transmitted by way of prior-art wireless data-transmission methods. A person skilled in the art may use a known position on the optical array generated by the collimated light to adapt the output signal from the optical array to a desired customized reading from the inclinometer.

Today, high-quality inclinometers can theoretically detect angular changes of 1 microrad.

Pixel sizes of standard image sensors may, for example, be in the order of 2.4 μm and have a resolution of 14 bits. This is to say that, from no light influence to light influence giving a maximum signal, an optical sensor that represents one pixel may give values between 0-16383. By using the technique described by the invention and using an image sensor having a pixel size of 2.4 μm and a pixel resolution of 14 bits, it is possible to have a position resolution of 2.4/16383 μm=0.00015 μm. With a pendulum having a length from the point of suspension to the image sensor of 1 m, this may detect angular changes of 0.000349 microrad, which is several thousand times better than what current solutions can offer. The pixel size of image sensors is becoming constantly smaller, and a size of 1 μm is common today.

The invention could also be used as a reading device for position determination and control of machines, wherein the light source and collimator are preferably built into the movable part of the machine, and wherein an optical array of a suitable type may be used on the static part of the machine in order thus to be able to indicate a position determination for the movable part relative to the static part so that the control system of the machine may perform the desired tasks with great precision.

### BRIEF DESCRIPTION OF THE DRAWINGS

In what follows, examples of preferred embodiments are described, which are visualized in the accompanying drawings, in which:

FIG. 1 shows a cross section of a joystick in one embodiment of the device;

FIG. 2 shows, in perspective, a joystick in another embodiment of the device;

FIG. 3 shows a view from the side of a joystick in which further details of the device are shown;

FIG. 4 shows a cross section of a joystick in still another embodiment of the device;

FIG. 5 shows a cross section of an embodiment of the device in the form of a computer mouse;

FIG. 6 shows a cross section of a collimator built into the movable part of the device;

FIG. 7 shows a cross section of a collimator built into the movable part of the device in another embodiment;

FIG. 8 shows a cross section of a collimator built into the movable part of the device in still another embodiment;

FIG. 9 shows a cross section of a collimator built into the movable part of the device in still another embodiment;

FIG. 10 shows a section of an optical array in which a position of the movable handle element is read in one embodiment of the device;

FIG. 11 shows a section of an optical array in which another position of the movable handle element is read in one embodiment of the device;

FIG. 12 sows a cross section of an embodiment of the device in the form of an inclinometer.

### DETAILED DESCRIPTION OF THE DRAWINGS

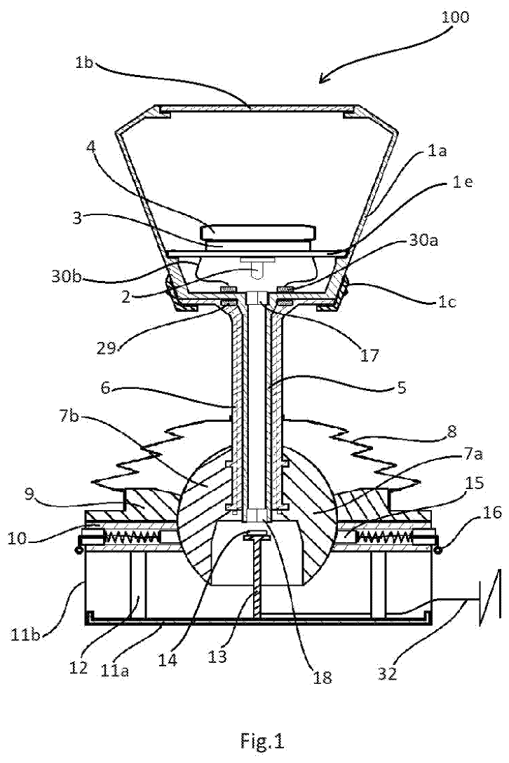

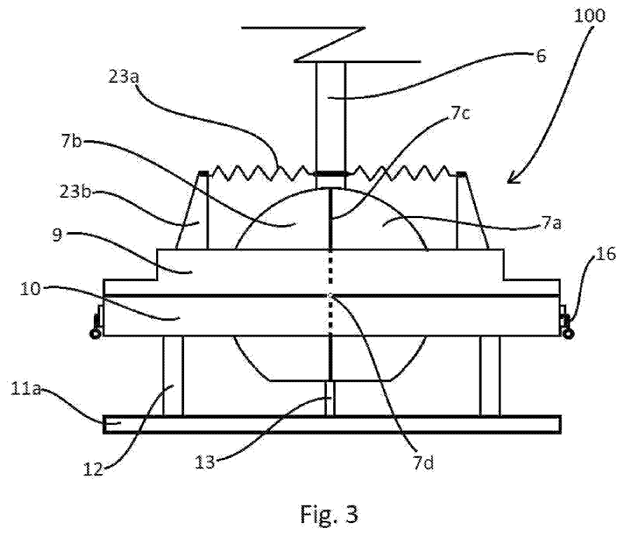

In the drawings, the reference numeral 100 indicates a reading device. FIG. 1 shows the reading device 100 which comprises a handle element 1a in which a light source 2 that can receive energy via a control circuit 3 and a battery 4 are installed. The handle element 1a may have an access hatch 1b for access to the components that are in the handle element 1a. As a continuation of the lower part of the handle element 1a, there is a tubular extension which forms a collimator housing 5. The shaft element 6 surrounds the collimator housing 5 and functions as a support for the collimator housing which, together with the handle element 1, is rotatable relative to the shaft element 6. A fastener 1c may be used to hold the handle element 1a and collimator housing 5 together with the shaft element 6. The shaft element 6 is attached to a ball half 7a and a ball half 7b which are made from an electrically conductive material with an insulating material between the ball halves (not shown). The ball half 7a and ball half 7b are held together by an upper joint half 9 and a lower joint half 10 which together with the ball half 7a and the ball half 7b form a ball joint. The lower joint half 10 is attached to a bottom structure 11a by means of spacers 12. In the bottom structure 11a, there is a mounting device 13 for an optical array 14 which is located below the pivotal point 7d of the ball joint. In the lower joint half 10, electrical brushes 15 which are in contact with the ball half 7a and the ball half 7b are arranged. The electrical brushes 15 are supplied with electric power via electrical connection points 16 and carry electric power via the electrical brushes 15, further through the ball half 7a and the ball half 7b, then on through an associated electrical connection in the shaft element 6 and on to an electrical inductive circuit consisting of a primary coil 29 arranged in the shaft element 6. A secondary coil 30a is arranged in the handle element 1a, and a connection between the secondary coil and the control circuit 3 is arranged with electrical connection 30b via a circuit board 1e which also functions as a mounting plate for the control circuit 3 and battery 4. The primary coil 29 and the secondary coil are arranged in line with each other. The light from the light source 2 is gathered by means of a collimator into one or more approximately unidirectional microscopic light beams. The collimator may consist of an upper collimator element 17 and a lower collimator element 18 which are each installed in a respective end of the collimator housing 5. The end of the lower collimator element 18 where the collimated light exits is preferably arranged in the pivotal point 7d of the ball joint shown in FIG. 3. The material of the ball half 7a and the ball half 7b has been removed under the pivotal point 7d of the ball to make room for an optical array 14 and its mounting device 13. The collimated light illuminating the optical array 14 gives position data related to the position of the handle element 1a, and data may be extracted via a data cable 32 and processed in a control unit or computer, for example for controlling a machine. To prevent impurities from getting into the reading unit 100, a rubber sleeve 8 may be installed and attached between the joint half 9 and the outer shaft element 6. To prevent undesired light from falling on the optical array 14, a casing 11b may be used. As a substitute for the bottom structure 11a and the casing 11b, a complete structure forming the sides and bottom may be used.

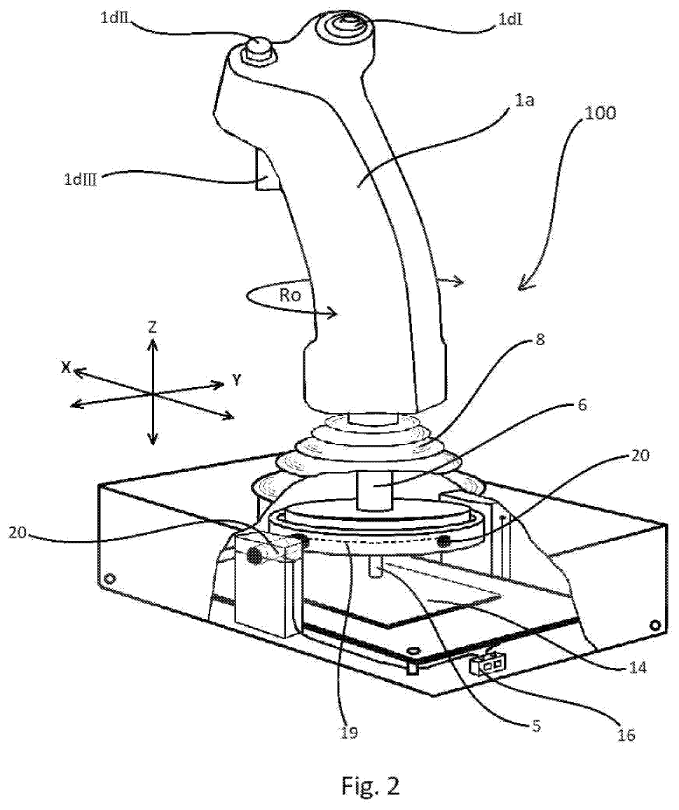

FIG. 2 shows a variant of a reading device 100 which is movable by means of a cardan suspension 19. Directional indications on the optical array 14 are in the horizontal plane by the x-axis, representing the directions forward/rearward, and the y-axis, representing the directions right/left. A direction in the vertical plane is indicated as the z-axis. A rotation around the z-axis is indicated as Ro. In such a variant, feeding electrical power to the light source can be done via an electrical connection 16, further via electrical conductors through the axles 20 of the cardan suspension 19 by the use of sliprings and further up to the light source (not shown) via the shaft element 6. In this variant, the handle element 1a is provided with extra control functions with switches 1dI, 1dII and 1dIII.

FIG. 3 shows a reading device 100 in which the handle element 1a is not shown. The centring of the handle element 1a in a neutral position consists in springs 23a that are attached between the outer shaft element 6 and fastening devices for springs 23b. Fastening devices for springs 23b typically consist of four units evenly spaced and attached to the upper joint half 9. The ball half 7a and the ball half 7b are electrically isolated from each other by an insulator 7c. The ball half 7a and the ball half 7b constitute the ball of the ball joint, and the centre point of the ball may be termed the pivotal point 7d of the ball.

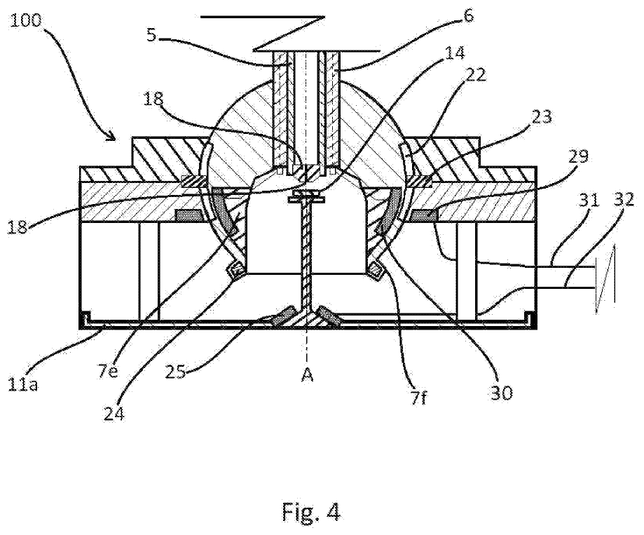

FIG. 4 shows a variant of a reading device 100 in which the handle element 1a is not shown. Electric power for the light source (not shown) is made by way of electrically induced voltage from the static part of the reading device 100 to the movable part of the reading device 100. An alternating current is supplied to a primary coil 29 via a supply cable 31. The alternating current induced in the secondary coil 30 is passed on through an electrical connection arranged from the secondary coil 30 via the shaft element to the control circuit 3 and the battery 4 (not shown) of the light source 2. After having been installed in the ball forming the ball joint, the secondary coil 30 may be anchored, for example by means of a potting compound 7e. The variant of the reading device 100 as shown in FIG. 4 is of a type which uses a ball joint as the pivotal point 7d of the handle element 1a (not shown) and in which rotation around the z-axis is a function used. To prevent the ball of the ball joint from rotating when the handle element 1a (not shown) and the collimator housing 5 with the lower collimator element 18 are being rotated, guiding grooves 22 may be made on both sides of the ball joint. The longitudinal direction of the guiding grooves 22 is oriented perpendicularly to the horizontal plane when the handle element 1a is in the centre position, and is preferably aligned on both sides of the ball on the x-axis or the y-axis and centred around the pivotal point 7d on the ball joint. The width of the guiding groove 22 may typically be 10% of its length. Between the upper joint half 9 and the lower joint half 10, cylindrical guide pins 23 are arranged, extending into the guiding groove 22. The ball joint will thus allow movement on the x-axis and y-axis without any possibility of the ball of the ball joint rotating around the z-axis. The length of the guiding groove 22 must be so long that it allows the desired movement of the movable part of the reading device 100 which will be restricted by the length of the guiding groove 22. As the technique used is not affected to any great extent by magnetic fields, centring of the handle element 1a may be carried out by means of a magnet 24 arranged in the lower part of the ball forming the ball joint. The magnet 24 may be an annular magnet of a permanent magnet type. In the bottom structure 11, a magnet 25 is arranged, which may be an annular magnet. The magnet 24 of the movable part of the reading device 100 and the magnet 25 of the static part of the reading device 100 are arranged with like magnet poles facing each other so that they repel each other and will thus keep the handle element 1a in a neutral position. The magnet 24 of the movable part of the reading device 100 and the magnet 25 of the static part of the reading device 100 may also be placed in another place that will give a centring of the handle element 1a. The magnet 25 of the static part may also be replaced by 3 or more solenoids on the bottom structure 11, evenly spaced around the centre line A which is formed by the centre of the collimator housing 5 when the handle element 1a is in its centre position. Alternatively, there is a set of solenoids (not shown) in addition to the magnet 25. This will make it possible to provide for a feedback to the handle element 1a on forces to which the thing(s) that the reading device 100 is to control is/are subjected, also called force feedback.

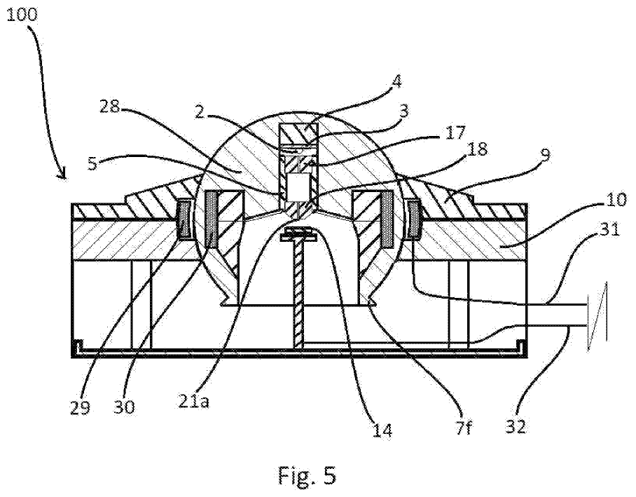

FIG. 5 shows a reading device 100 in a trackball embodiment for use as a computer mouse. The control circuit 3 and the battery 4 for supplying the light source 2 are built into the trackball 28, together with the collimator which may consist of an upper collimator element 17 and a lower collimator element 18. The collimator housing 5 may also consist of an element that has the microscopic aperture. An alternative to a collimator housing 5 mounted in the trackball 28 is that the material in the trackball 28 forms the collimator with the microscopic aperture. The trackball 28, the upper joint half 9 and the lower joint half 10 may be provided with guiding grooves 22 and cylindrical guide pins 23 (not shown), as shown in FIG. 4, to avoid rotation of the trackball around the z-axis. The reading device 100 may also be used without guiding grooves 22 and cylindrical guide pins 23 as a collimator having just one aperture 21a is being used and a rotation around the z-axis will not affect the position reading of the light beam on the optical array 14. The trackball 28 may have a stop edge 7f which restricts the movement of the trackball 28 by the stop edge 7f stopping against the lower joint half 10 and ensuring that the light spot from the collimator will not go beyond the chosen reading area of the optical array 14. Power supply to the light source 2 may be done via an electrical primary coil 29 which may be placed between the upper joint half 9 and the lower joint half 10, receiving supply voltage via a supply cable 31. The primary coil 29 is inductively connected to a secondary coil 30 which is electrically connected to the control circuit 3 of the light source 2 which may charge a battery 4 in order to give a controlled voltage to the light source and thus a more even light intensity. Power supply may also be done via electrical brushes as described for the reading device 100 of FIG. 1. Power supply may also be carried out by the battery 4 being charged by means of a charging contact or inductive charging of a battery 4 when the reading device 100 is not in use. Data from the optical array 14 are extracted from the reading device 100 via a data cable 32, or data are transmitted to the computer via prior-art wireless communication techniques.

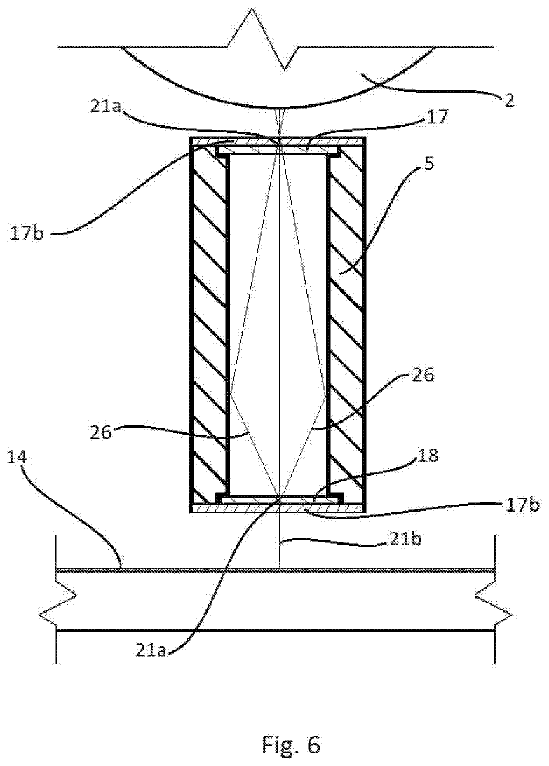

FIG. 6 shows a selection of elements of a reading device 100 in which light from a light source 2 is collimated and directed at an optical array 14 by means of a version of the collimator that may indicate positions on the x- and y-axis. The collimator may consist of a collimator housing 5, an upper collimator element 17 and a lower collimator element 18 being mounted in the collimator housing 5. Transparent collimator-element protection 17b is fitted to the outside of the upper collimator element 17 and the lower collimator element 18. The upper collimator element 17 and the lower collimator element 18 have only one aperture 21a at the centre of the collimator housing 5. The collimator may also consist of more than two collimator elements with apertures 21a arranged in line in order to form a collimated light beam 21b. The collimator housing 5, the upper collimator element 17 and the lower collimator element 18 will preferably be made of a black matt material which absorbs light entering through the upper collimator element 17 at an angle to the line indicating a collimated light beam 21b. This will prevent light reflections 26 that might arise in the collimator housing 5 and thus minimize the possibility for light to pass the lower collimator element 18 at an angle to the desired collimated light beam 21b. The diameter of the aperture 21a is typically in the region of 1.5 times larger than a pixel of the optical array 14. This will ensure that the light spot that illuminates the optical array 14 will always illuminate a pixel 14a, thus avoiding a drop-out of the position signal.

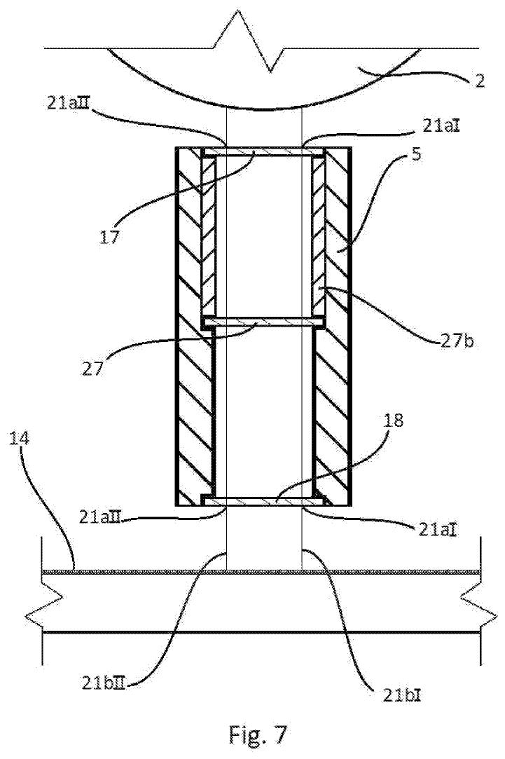

FIG. 7 shows a selection of elements of a reading device 100 in which light from a light source 2 is collimated and directed at an optical array 14 by means of a version of a collimator that can indicate positions on the x- and y-axis and also rotation around the z-axis. The upper collimator element 17 and the lower collimator element 18 are arranged with two apertures 21aI and 21aII, giving two collimated light beams 21bI and 21bII. To prevent light entering through the aperture 21aI of the upper collimator element 17 at an angle relative to the direction of the apertures from passing the aperture 21aII of the lower collimator element 18 and making the light beam that hits the optical array 14 into a light beam that does not correspond to the diameter and shape of the apertures 21aI and 21aII, the collimator may be provided with a middle collimator element 27 which will stop light entering the upper collimator element 17 at an angle to the collimated light beams from continuing down towards the lower collimator element 18. A middle collimator element 27 may be installed and held in place by a supporting sleeve 27b. The apertures in the upper collimator element 17, the lower collimator element 18 and the middle collimator element 17 are of identical designs, positioning and have the same orientation in the horizontal plane. One light beam will preferably be aligned with the pivotal point on the reading device 100 and represent the position of the reading device, and the other light beam will be used to determine the degree of rotation around the z-axis.

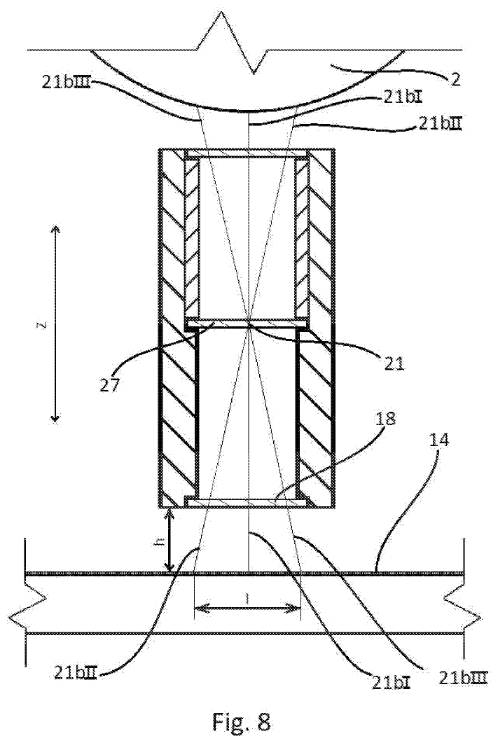

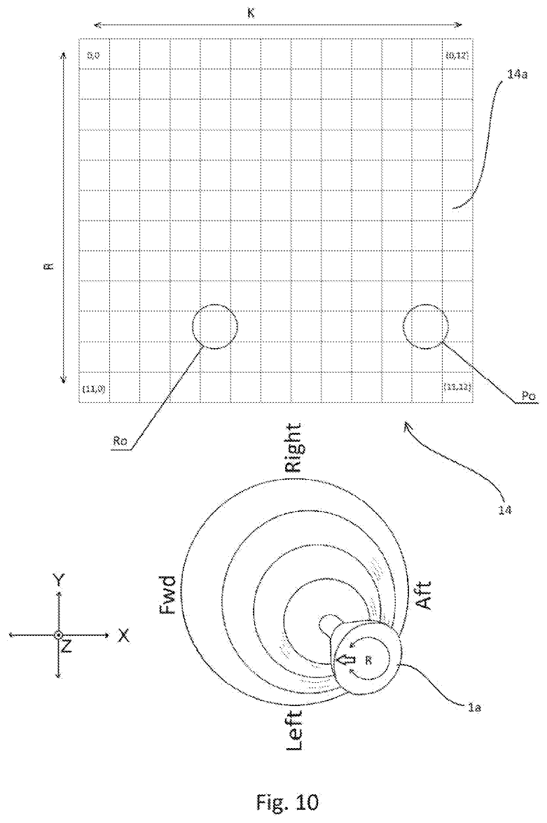

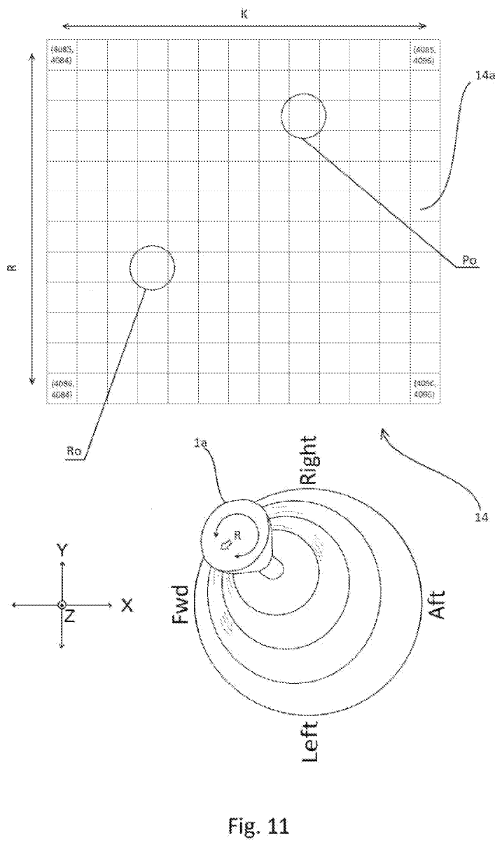

FIG. 8 shows a selection of elements of a reading device 100 in which light from a light source 2 is collimated and directed at an optical array 14, and which can indicate the position of the handle element 1a (not shown) on the x- and y-axis, and the position of the handle element 1a (not shown) on the z-axis and also rotation around the z-axis. The collimator has an upper collimator element 17 and a lower collimator element 18 with three apertures, the three apertures being oriented on the same line in the horizontal plane. A middle collimator element 27 having an aperture at its centre may be used to reduce the spreading of the light beams in the same way as described for the collimator of FIG. 7. The light beam 21bI may be used to indicate the position of the handle element 1a on the x- and y-axis. The light beam 21bII and the light beam 21bIII form an angle relative to the light beam 21bI. When the handle element 1a with the collimator is moved in the direction z, with an increasing distance h between the collimator and the optical array 14, the distance l between the light beam 21bII and the light beam 21bIII will increase. When the handle element 1a with the collimator is moved in the direction z, with decreasing distance h between the collimator and the optical array 14, the distance l between the light beam 21bII and the light beam 21111 will decrease. A change in the position of the handle element 1a in the z-direction may thus be determined by using the difference between the highest row figure and the lowest row figure on the optical array in the program processing the signals of the reading device 100 and thus give a reading device 100 an extra dimension for position determination. To calculate the rotational direction and the degree of rotation, 21bII and 21bIII may be used, for example. This principle will be described in further detail with FIG. 10 and FIG. 11.

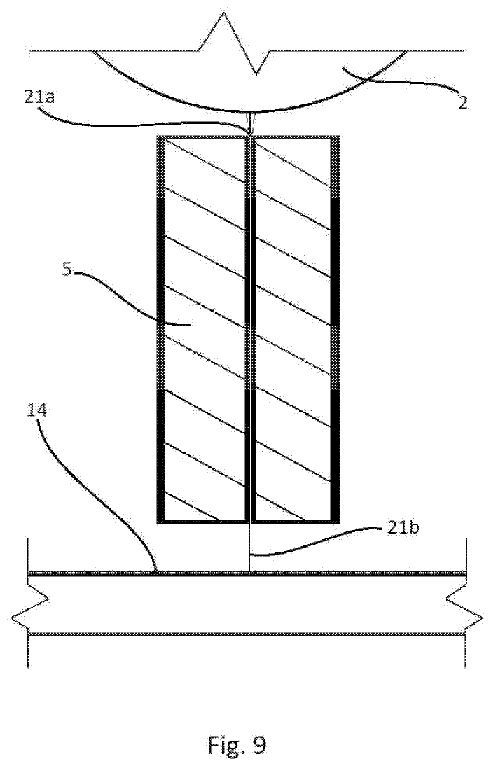

FIG. 9 shows a selection of elements of a reading device 100 in which light from a light source 2 is collimated and directed at an optical array 14 by means of a collimator that indicates positions only in the x- and y-direction, the collimator housing 5 consisting of just one element. The length from the aperture 21a, where the light enters, to the aperture where collimated light 21b exits the collimator housing 5 will be of importance to the spreading of light, and an aperture of a large length gives less light-spreading of the light exiting a collimator element than an aperture of a shorter length.

In FIG. 10 and FIG. 11 it is described how the position of a handle element 1a can be determined by means of the technique covered by the invention. In FIGS. 10 and 11, a section of an optical array 14 which is indexed by each pixel 14a having its address indicated by a first digit as the row number and a second digit as the column number which we call the index number. For information, index numbers of pixels in the optical array 14 are indicated in all four corners of the section. In the example given, a handle element 1a that has forward/aft and right/left movement and a possibility of rotation around the z-axis has been chosen. The optical array 14 has 4096×4096 pixels 14a. The rows R represent the position of the handle element 1a in the y-direction, and the column K represents the position of the handle element 1a in the x-direction. In this example, the index numbering of the individual pixels 14a is given as a first figure=row and a second figure=column. A centre position of the optical array then has an index number 2048,2048. The position indication for the handle element 1a may be chosen to be the signal generated by the collimated light spot that is on the highest column figure. A movement of the handle element 1a forwards will move the light spots towards an increasing column figure, and a movement of the handle element 1a rearwards will move the light spots towards a decreasing column figure. A movement of the handle element 1a towards the left will move the light spots towards a decreasing row figure and a movement of the handle element 1a towards the right will move the light spots towards an increasing row figure. The handle element 1a is preferably mechanically restricted in such a way that the light spots will stay inside the optical array 14.

FIG. 10 shows a section of an optical array 14 in which the handle element 1a is in the position at the extreme rear and extreme left. Index numbers of pixels in the optical array 14 are indicated in all four corners of the section of the optical array 14. The handle element 1a has no rotation around the z-axis which is indicated on the handle element 1a by an arrow that corresponds to the direction straight forward. The handle element 1a is provided with a collimator which gives two light spots on the optical array 14. The light spot Po indicates the position of the handle element 1a, and the light spot Ro will, together with the position of Po, be determinant for calculating the direction of rotation and magnitude of a rotation signal i. The light spots are positioned along the same row figure when there is no rotation around the z-axis, and the light spot of the handle element 1a for position indication Po=9,10 and the light spot for the rotation indication Ro=9,4. In this case the row figure is 9 for Po and Ro.

In FIG. 11, the handle element 1a is in the position extreme forward and extreme left, and the mechanical restriction of the handle element 1a gives the light spot for the position indication Po an index number=4087,4092 in the example. A maximum angle of rotation may be mechanically restricted to 45 degrees, and rotation around the z-axis is, in this case, 45 degrees towards the left. The light spot for the rotation indication Ro then has the index number 4092,4087. A row figure for the light spot Ro which is higher than the row figure for Po will indicate rotation towards the left, and a row figure for the light spot Ro that is lower than the row figure for Po will indicate rotation towards the right. A maximum rotation towards the left gives a row figure for Ro that has a value higher by 5 than the row figure of Po. When the handle element 1a is moved back towards zero rotation, a higher row figure for Ro than for Po will decrease until the row figure values are identical. A maximum rotation towards the right will give a row figure for Ro which is lower by 5 than the row figure for Po. In that way, the magnitude of the rotation signal and the direction of rotation may be calculated. By increasing the distance between the apertures 21a in the collimator, one will get an increased resolution of a rotation signal if this is desirable.

A person skilled in the art may use data from the optical array 14 generated by the collimated light from the collimator of the reading device 100 and provide for the output signal to user equipment to be of the desired standard. This may be done by necessary control electronics being located in the reading device 100 or being located separately from the reading device. Data from the optical array 14 may also be coupled directly to a computer and by means of the necessary software generate control signals to units that are to be controlled by the reading device 100.

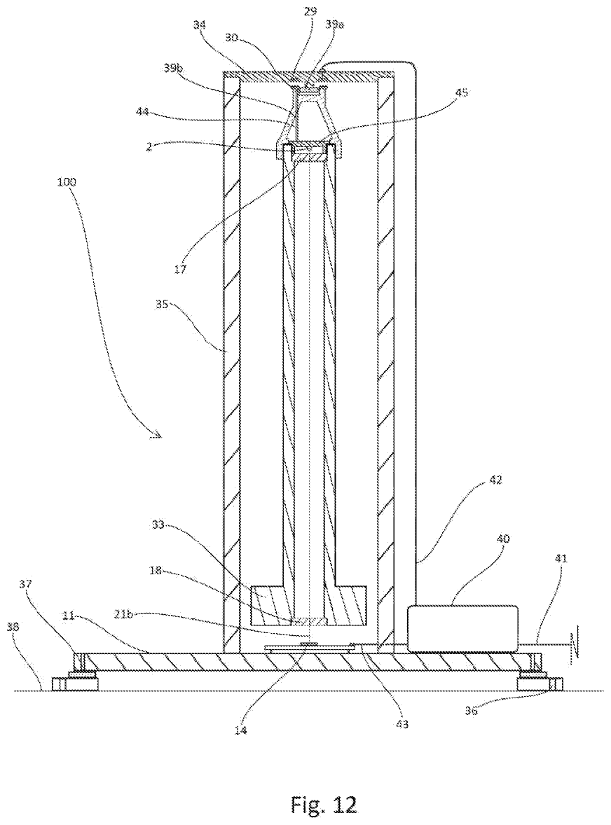

FIG. 12 shows a reading device in the form of an inclinometer in which a pendulum 33 is suspended from an upper structure 34 by means of a universal joint which has an upper joint segment 39a and a lower joint segment 39b with low friction. Another type of device for suspending the pendulum may also be used. The upper structure 34 may consist of a detachable lid for access to the pendulum 33 with its contents. The upper structure 34 with the pendulum 33 is held by an outer structure 35 which may be a tubular cylinder which is installed on a bottom structure 11. In the pendulum 33, a light source 2 and a collimator consisting of an upper collimator element 17 and a lower collimator element 18 are arranged, the pendulum 33 constituting the collimator housing. The collimator may also be an independent collimator housing which is fitted into the pendulum 33. The light source 2 may be supplied with electric power by induced voltage transmission between the static part and the movable part of the reading device 100. This may be done by the control unit 40 being supplied with electric power via a supply cable 41 which may then supply the light source 2 with electric power via a cable 42 extending to the light source 2 via a primary coil 29 in the upper structure 34 and a secondary coil 30 installed in the top of the lower joint segment 39b and via a cable 44 to a light-control circuit 45. The collimated light 21b is directed at an optical array 14 which is mounted on the bottom structure 11. The bottom structure 11 may be fixed to the supporting surface that is to be monitored for angular changes by means of preferably three attachment points 36. The bottom structure 11 may have adjustments 37 so that, after installation on the supporting surface 38, the inclinometer may be adjusted in such a way that the collimated light 21b hits the centre of the optical array 14. If, over time, there is an angular change in the supporting surface 38, this will result in the pendulum and the collimated light 21b moving on the optical array 14 and new position data being transmitted to the control unit 40 via the signal cable 43. The amount of angular change and the direction of the angular change may be calculated in the control unit 40. The control unit 40 may also be located on the inside of the outer structure 35 or as part of a common circuit board on which the optical array 14 is located as well. The bottom structure 11 and the outer structure 35 are made lightproof so that only the collimated light 21b illuminates the optical array 14. The inclinometer may be installed in varying forms of outer structures 35. The inclinometer may have control electronics in the control unit 40 which make measurements continuously or at desired intervals, wherein data may be read directly on the inclinometer or stored on a built-in storing medium. Data may also be transmitted to a computer which may be integrated in the reading unit 100 or which is an external unit in which data are processed, stored or transmitted over an Internet connection to a receiver according to the prior art. A person skilled in the art may use data from the optical array 14 that are generated by the collimated light from the collimator of the reading device 100 and provide for a desired reading for a user of the equipment.

It should be noted that all the above-mentioned embodiments illustrate the invention, but do not limit it, and persons skilled in the art may construct many alternative embodiments without departing from the scope of the attached claims. In the claims, reference numbers in brackets are not to be regarded as restrictive.

The use of the verb “to comprise” and its different forms does not exclude the presence of elements or steps that are not mentioned in the claims. The indefinite article “a” or “an” before an element does not exclude the presence of several such elements.

1. A reading device for reading a positional relationship between a first component and a second component, wherein the first component comprises an optical sensor and wherein the second component comprises a collimator configured for directing a light beam at the optical sensor by the collimator comprising a collimator housing with two openings opposite each other, each in a respective end part of the collimator housing.

2. The reading device according to claim 1, wherein the size of the openings and the distance between the openings in the collimator are so adapted that the light beam behind the collimator has a cross section of an extent smaller than 50 μm.

3. The reading device according to claim 2, wherein the size of the openings and the distance between the openings of the collimator are arranged in such a way that the light beam after the collimator has a cross section of an extent smaller than 10 μm.

4. The reading device according to claim 1, wherein the optical sensor is an image sensor.

5. The reading device according to claim 1, wherein the optical sensor has a pixel size with dimensions smaller than 50 μm.

6. The reading device according to claim 1, wherein the optical sensor has a pixel size with dimensions smaller than 10 μm.

7. The reading device according to claim 1, wherein the collimator is further configured for directing a second light beam at the optical sensor.

8. The reading device according to claim 7, wherein the collimator is further configured in such a way that the light beams hit the optical sensor at different angles.

9. The reading device according to claim 1, wherein the collimator, on its inside, has a surface which absorbs light.

10. A method for reading a positional relationship between two components, wherein the method comprises the steps of:
passing light through a collimator in a second component to an optical sensor in a first component, the collimator comprising a collimator housing with two openings opposite each other, each in a respective end part of the collimator housing;
reading the position of the light beam from the collimator on the optical sensor; and
calculating the positional relationship between the first and second components from the position of the light beam on the optical sensor.

11. The method according to claim 10, wherein the positional relationship between the two components is read by using the reading device.
